(19) United States
(12) Patent Application Publication
(10) Pub. No.: US 2025/0175089 A1
(43) Pub. Date: May 29, 2025

(54) RESONANT POWER CONVERTER CIRCUIT WITH ADAPTIVE ON-TIME CONTROL AND METHOD THEREOF

(71) Applicant: Chengdu Monolithic Power Systems Co., Ltd., Chengdu (CN)

(72) Inventors: Yuzhou Zhang, Hangzhou (CN); Pengfei Liu, Hangzhou (CN)

(21) Appl. No.: 18/961,991

(22) Filed: Nov. 27, 2024

(30) Foreign Application Priority Data
Nov. 29, 2023 (CN) 202311623762.2

(51) Int. Cl. H02M 3/335; H02M 1/00; H02M 3/00

(52) U.S. Cl. CPC H02M 3/33571; H02M 1/0009; H02M 3/01

(57) ABSTRACT

A control circuit for an asymmetrical half-bridge flyback converter with a first switch, a second switch, a transformer and a resonant capacitor is provided. The control circuit includes an input terminal and an output terminal. The input terminal receives resonant current information. The resonant current information is associated with a resonant current flowing through a resonant tank formed by a primary winding of the transformer and a resonant capacitor. The output terminal provides a first control signal to turn off the first switch of the asymmetrical half-bridge flyback converter based on the resonant current information.

### CROSS-REFERENCE TO RELATED APPLICATIONS

This application claims the benefit of and priority to a CN application Ser. No. 20/231,1623762.2, filed on Nov. 29, 2023, which is incorporated herein by reference into the present application.

### TECHNICAL FIELD

The present invention generally relates to electronic circuits, and more particularly but not exclusively, to control circuits for resonant power converter circuits and associated control methods.

### BACKGROUND

A conventional power converter circuit converts an input power to a desired output power providing to a load. A resonant power converter circuit adopts soft switching technology to reduce switching loss of the circuit, thereby improving the efficiency.

As a type of resonant power converter circuits, asymmetrical half-bridge flyback converters have been widely used due to its advantages such as simple structure, high efficiency, and wide output voltage range. However, since the output voltage range of the asymmetrical half-bridge flyback converter is wide, the power loss is large when it operates at the rated output voltage condition (i.e., the output voltage is close to its upper limit value). In order to improve the efficiency when the asymmetrical half-bridge flyback converter operates at the rated output voltage condition, the efficiency when it operates at a low output voltage condition is usually sacrificed.

### SUMMARY

An embodiment of the present invention discloses a control circuit for an asymmetrical half-bridge flyback converter with a first switch, a second switch, a transformer and a resonant capacitor is provided. The control circuit includes an input terminal and an output terminal. The input terminal receives resonant current information. The resonant current information is associated with a resonant current flowing through a resonant tank formed by a primary winding of the transformer and the resonant capacitor. The output terminal provides a first control signal to turn off the first switch of the asymmetrical half-bridge flyback converter based on the resonant current information.

Another embodiment of the present invention discloses a power device. The power device includes an asymmetrical half-bridge flyback converter and a control circuit. The asymmetrical half-bridge flyback converter includes a first switch, a second switch, a transformer and a resonant capacitor. The first switch and the second switch are coupled in series between an input terminal and a primary side reference ground terminal. The transformer includes a primary winding and a secondary winding, and a resonant tank is formed by the primary winding and the resonant capacitor. The control circuit receives resonant current information associated with a resonant current flowing through the resonant tank and provides a first control signal to turn off the first switch based on the resonant current information.

Yet another embodiment of the present invention discloses a method for controlling a resonant power converter circuit with a first switch, a second switch, a transformer and a resonant capacitor. The first switch and the second switch in the resonant power converter circuit are controlled to regulate energy transfer from a primary winding to a secondary winding of the transformer. A resonant tank of the resonant power converter circuit is formed by the primary winding and the resonant capacitor. Resonant current information associated with a resonant current flowing through the resonant tank is received. The first switch is turned off based on the resonant current information.

### BRIEF DESCRIPTION OF DRAWINGS

The present invention can be further understood with reference to the following detailed description and the appended drawings, wherein like elements are provided with like reference numerals.

FIG. 1 shows a schematic diagram of a conventional asymmetrical half-bridge flyback converter.

FIG. 2 shows schematic waveforms of the conventional asymmetrical half-bridge flyback converter operating at a low output voltage condition.

FIG. 3 shows a schematic diagram of a power device in accordance with an embodiment of the present invention.

FIG. 4 shows a schematic diagram of a power device in accordance with an embodiment of the present invention.

FIG. 5 shows schematic waveforms of the power device in accordance with an embodiment of the present invention.

FIG. 6 shows a schematic diagram of a power device in accordance with another embodiment of the present invention.

FIG. 7 shows a schematic diagram of a power device in accordance with yet another embodiment of the present invention.

FIG. 8 shows a schematic diagram of a power device in accordance with yet another embodiment of the present invention.

FIG. 9 shows a schematic diagram of a resonant power converter circuit in accordance with an embodiment of the present invention.

FIG. 10 shows a schematic diagram of a resonant power converter circuit in accordance with an embodiment of the present invention.

FIG. 11 shows a schematic diagram of a resonant power converter circuit in accordance with an embodiment of the present invention.

FIG. 12 shows a schematic diagram of a resonant power converter circuit in accordance with an embodiment of the present invention.

FIG. 13 shows a schematic diagram of a power device in accordance with an embodiment of the present invention.

FIG. 14 shows schematic waveforms of the power device in accordance with an embodiment of the present invention.

FIG. 15 shows a schematic diagram of a power device in accordance with yet another embodiment of the present invention.

FIG. 16 shows a flow diagram of a method for controlling a resonant power converter circuit in accordance with an embodiment of the present invention.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

Reference to “one embodiment”, “an embodiment”, “an example” or “examples” means: certain features, structures, or characteristics are contained in at least one embodiment of the present invention. These “one embodiment”, “an embodiment”, “an example” and “examples” are not necessarily directed to the same embodiment or example. Furthermore, the features, structures, or characteristics may be combined in one or more embodiments or examples. In addition, it should be noted that the drawings are provided for illustration and are not necessarily to scale. And when an element is described as “connected” or “coupled” to another element, it can be directly connected or coupled to the other element, or there could exist one or more intermediate elements. In contrast, when an element is referred to as “directly connected” or “directly coupled” to another element, there is no intermediate element.

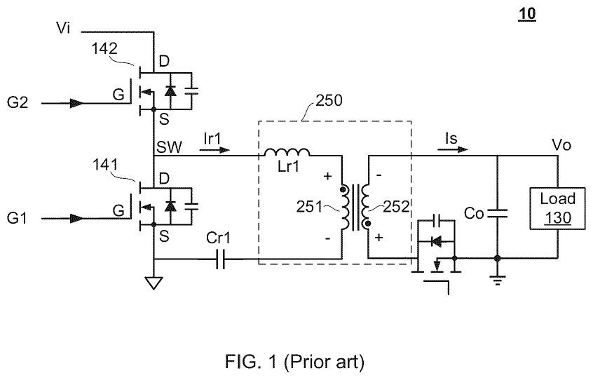

FIG. 1 shows a schematic diagram of a conventional asymmetrical half-bridge flyback converter 10. As shown in FIG. 1, a first switch 141 is controlled by a first control signal G1 and a second switch 142 is controlled by a second control signal G2. Under the control of the first control signal G1 and the second control signal G2, the first switch 141 and the second switch 142 are turned on alternately. Thus, an input voltage Vi of the asymmetrical half-bridge flyback converter 10 is converted to an output voltage Vo for powering a load 130. In some embodiments, the first control signal G1 and the second control signal G2 are Pulse Width Modulation (PWM) signals. By adjusting pulse widths of the first control signal G1 and the second control signal G2, the asymmetrical half-bridge flyback converter 10 could meet different input and output conditions.

Typically, the first switch 141 is turned off after a transformer 250 is demagnetized to improve the efficiency. A demagnetization time of the transformer 250 is associated with a peak value of a resonant current Ir1 flowing through a primary winding 251 of the transformer 250, and the output voltage Vo. When the range of the output voltage Vo of the asymmetrical half-bridge flyback converter 10 is wide, for example, the output voltage Vo ranges from 5V-48V in some applications. In this case, when the asymmetrical half-bridge flyback converter 10 operates at the output voltage condition of 48V, the power loss is largest. Accordingly, the design of the demagnetization time of the asymmetrical half-bridge flyback converter 10 is based on the output voltage condition of 48V. However, the efficiency is poor when the asymmetrical half-bridge flyback converter 10 operates at a low output voltage condition.

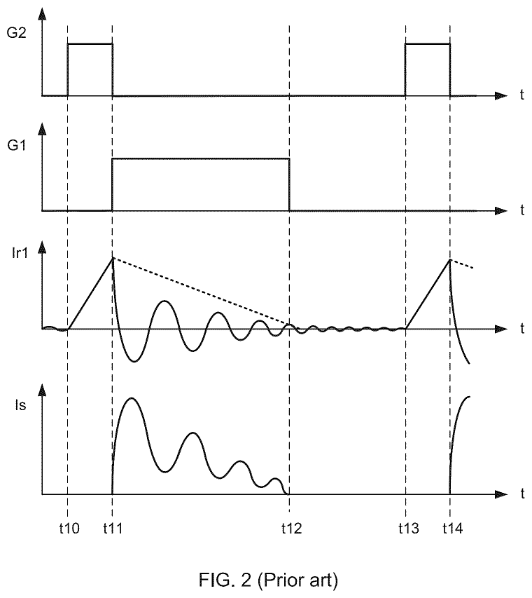

FIG. 2 shows schematic waveforms of the conventional asymmetrical half-bridge flyback converter 10 operating at the low output voltage condition. As shown in FIG. 2, during time t10-t11, the first switch 141 is off and the second switch 142 is on. Meanwhile, the primary winding 251 of the transformer 250 is charged by the input voltage Vi, the resonant current Ir1 increases, and the primary winding 251 stores energy. During time t11-t12, the first switch 141 is on and the second switch 142 is off. Meanwhile, as the resonant current Ir1 decreases, the energy stored in the primary winding 251 is transferred to a secondary winding 252, generating a current Is flowing through the secondary winding 252. Due to the output voltage Vo is small, the demagnetization of the primary winding 251 of the transformer 250 is finished at time t12. Accordingly, the first switch 141 is turned off at the time t12. However, before t12, a leakage inductance Lr1 of the primary winding 251 of the transformer 250 and a resonant capacitor Cr1 form a resonant tank, and the resonant current Ir1 of the resonant tank generates oscillations, resulting in large power loss, which reduces efficiency.

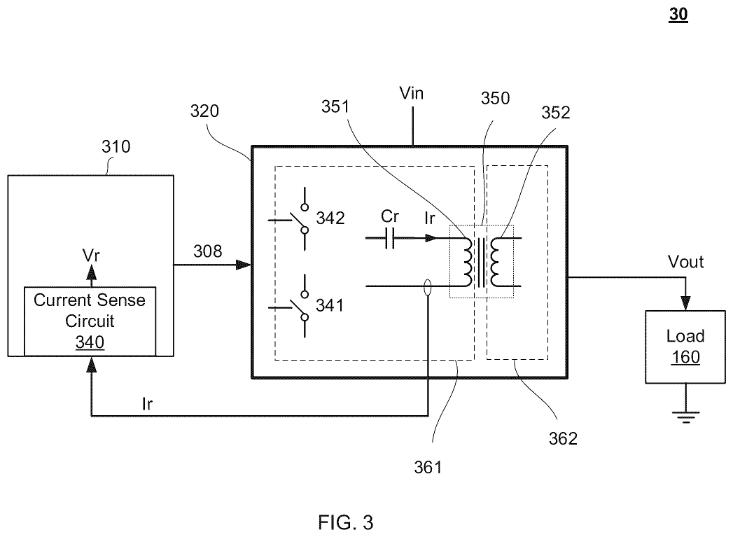

FIG. 3 shows a schematic diagram of a power device 30 in accordance with an embodiment of the present invention. As shown in FIG. 3, the power device 30 includes a resonant power converter circuit 320 and a control circuit 310 for controlling the resonant power converter circuit 320. The resonant power converter circuit 320 includes a first switch 341, a second switch 342, a transformer 350 and a resonant capacitor Cr. The transformer 350 includes a primary winding 351 and a secondary winding 352.

It should be understood that, in this embodiment, the resonant power converter circuit 320 is an asymmetrical half-bridge flyback converter. However, the present invention is not limited thereto. For example, the resonant power converter circuit 320 may include, but not limited to, an LLC (Inductor-Inductor-Capacitor) circuit or other power converter circuits. The control circuit 310 may be realized by a digital circuit, an analog circuit, a combination of digital circuit and analog circuit, a software, an automatic generation circuit by hardware description language or a combination of the above. In one implementation, the control circuit 310 is realized by an integrated circuit. In another implementation, the control circuit 310 is realized by a general-purpose processor or an application specific processor with a program.

As shown in FIG. 3, the resonant power converter circuit 320 receives an input voltage Vin. The primary winding 351 is coupled magnetically with the secondary winding 352. The primary winding 351 stores energy provided from the input voltage Vin. The stored energy is transferred to the secondary winding 352 to generate an output voltage Vout. In the resonant power converter circuit 320, a primary side circuit 361 is the circuit electrically connected to, whether directly or indirectly, the primary winding 351, while a secondary side circuit 362 is the circuit electrically connected to, whether directly or indirectly, the secondary winding 352.

During operation of the power device 30, the control circuit 310 provides one or more control signal(s) 308 (e.g., PWM signals) to control the first switch 341 and the second switch 342 of the resonant power converter circuit 320, thereby providing the suitable output voltage Vout to a load 160.

The first switch 341 may be coupled in series with the second switch 342. The first switch 341 is controlled to be turned on and off alternately with the second switch 342 by the control circuit 310. Thus, the first switch 341 and the second switch 342 are alternately participate in a current loop including the primary winding 351, to transfer the energy from the primary winding 351 to the secondary winding 352. The alternating on and off of the first switch 341 and the second switch 342 causes the change of the current flowing through the primary winding 351, thus energy could be stored in the primary winding 351. The energy is transferred from the primary winding 351 to the secondary winding 352, and the secondary winding 352 converts the energy to the output voltage Vout for powering the load 160.

The first switch 341 and second switch 342 may be realized by any suitable controllable switches, such as a field effect transistor and a bipolar transistor.

In one embodiment of the present invention, the primary side circuit 361 of the resonant power converter circuit 320 generates a resonant current Ir. The control circuit 310 converts the resonant current Ir to a first signal Vr by a current sense circuit 340, and turns off the first switch 341 based on the first signal Vr. In one embodiment, the first signal Vr is a voltage signal which is converted from the resonant current Ir, and therefore they have similar waveforms. Based on the first signal Vr, an on-time of the first switch 341 is controlled to improve the efficiency of the resonant power converter circuit 320 operating at the low output voltage condition. The working principle of controlling the on-time of the first switch 341 based on the first signal Vr will be described in detail below.

In some embodiments of the present invention, information of the resonant current Ir could be estimated based on parameter information in the specific application. The estimated information of the resonant current Ir could also be utilized to control the on-time of the first switch 341.

It should be understood that the resonant power converter circuit of the present invention could employ any suitable topology. For example, in some embodiments of the present invention, the resonant power converter circuit employs an asymmetrical half-bridge flyback topology. In some other embodiments, the resonant power converter circuit of the invention employs LLC topology and the like.

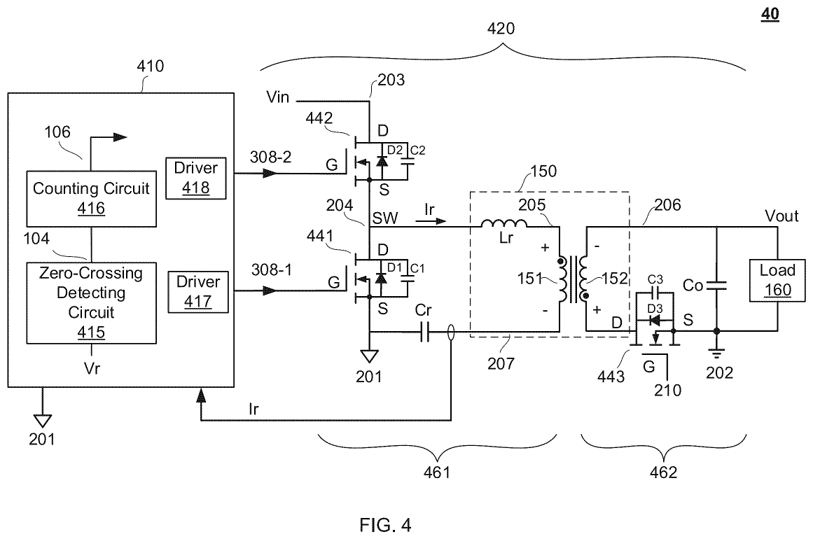

FIG. 4 shows a schematic diagram of a power device 40 in accordance with an embodiment of the present invention. As shown in FIG. 4, the power device 40 includes a resonant power converter circuit 420 and a control circuit 410 for controlling the resonant power converter circuit 420. In one embodiment, the resonant power converter circuit 420 is an asymmetrical half-bridge flyback converter, including a first switch 441, a second switch 442, a resonant capacitor Cr, a transformer 150, a third switch 443 and an output capacitor Co. The transformer 150 includes a primary winding 151 and a secondary winding 152. In the embodiment of FIG. 4, a resonant inductor Lr is the leakage inductance of the primary winding 151. In some embodiments, the resonant inductor Lr is a discrete inductor. In some other embodiments, the resonant inductor Lr is a combination of the discrete inductor and the leakage inductance of the primary winding 151.

It should be understood that the primary winding 151 and components electrically coupled to the primary winding 151 (e.g., the first switch 441, the second switch 442, the resonant capacitor Cr and other components not shown in the drawings) form a primary side circuit 461. The secondary winding 152 and components electrically coupled to the secondary winding 152 (e.g., the third switch 443, the output capacitor Co and other components not shown in the drawings) form a secondary side circuit 462.

In the embodiment of FIG. 4, the first switch 441, the second switch 442 and third switch 443 are realized by Metal Oxide Semiconductor Field Effect Transistors (MOSFETs). For instance, the first switch 441 has a gate terminal G, a drain terminal D, a source terminal S, a body diode D1 and a source-drain capacitance C1. The second switch 442 has a gate terminal G, a drain terminal D, a source terminal S, a body diode D2 and a source-drain capacitance C2. The third switch 443 includes a gate terminal G, a drain terminal D, a source terminal S, a body diode D3 and a source-drain capacitance C3. It should be appreciated that the body diodes D1-D3 of the switches 441-443 are parasitic diodes.

In the embodiment of FIG. 4, the control circuit 410 includes a driver 417 and a driver 418 for driving the first switch 441 and the second switch 442, respectively. The driver 417 and driver 418 are configured to receive control signals of the first switch 441 and the second switch 442, and to enhance the driving capability of the control signals. The enhanced control signals are provided to the gate terminal G of the first switch 441 and the gate terminal G of the second switch 442 to control the first switch 441 and the second switch 442, respectively. The drain terminal D of the second switch 442 is coupled to an input terminal 203 to receive the input voltage Vin. The source terminal S of the second switch 442 is coupled to a switching terminal 204. The drain terminal D of the first switch 441 is coupled to the switching terminal 204. The source terminal S is coupled to a primary side reference ground terminal 201. The first switch 441 and the second switch 442 are coupled to a first terminal of the primary winding 151 of the transformer 150 through the switching terminal 204. A second terminal of the primary winding 151 of the transformer 150 is coupled to a first terminal of the resonant capacitor Cr. A second terminal of the resonant capacitor Cr is coupled to the primary side reference ground terminal 201.

In some embodiments of the present invention, the resonant power converter circuit 420 has a resonant tank formed by the resonant inductor Lr, the resonant capacitor Cr and the primary winding 151 of the transformer 150. The resonant tank is coupled between the switching terminal 204 and the primary side reference ground terminal 201. In other words, the primary winding 151 and the resonant capacitor Cr are coupled in series between the switching terminal 204 and the primary side reference ground terminal 201.

In the embodiment of FIG. 4, the driver 417 and the driver 418 are integrated in the control circuit 410. In some embodiments, the driver 417 is integrated with the first switch 441, and the driver 418 is integrated with the second switch 442. It should be appreciated that, some or all of the driver 417, the driver 418, the first switch 441, the second switch 442 could be integrated with the control circuit 410 in one or more integrated circuit(s).

As shown in the embodiment of FIG. 4, the secondary winding 152 of the transformer 150 is coupled between an output terminal 206 and the third switch 443. In other words, the secondary winding 152 and the third switch 443 are coupled in series between the output terminal 206 and a secondary side reference ground terminal 202. In the embodiment of FIG. 4, the third switch 443 is a MOSFET. A control signal 210 is provided to the gate terminal G of the third switch 443 for controlling the third switch 443. In one embodiment, the control signal 210 is provided by the control circuit 410. In some embodiments, the control signal 210 is provided by other suitable control circuits. In some other embodiments, the third switch 443 is replaced by a diode.

The output capacitor Co is coupled between the output terminal 206 and the secondary side reference ground terminal 202.

As illustrated before, the resonant tank includes the resonant inductor Lr, the resonant capacitor Cr and the primary winding 151 of the transformer 150. The control circuit 410 provides a first control signal 308-1 to control the first switch 441 and a second control signal 308-2 to control the second switch 442. Furthermore, the switching frequency of the first switch 441 and the second switch 442 is controlled to be equal or approximate to the resonant frequency of the resonant tank. The first switch 441 and the second switch 442 are alternately turned on and off. When the first switch 441 is off and the second switch 442 is on, the resonant tank stores energy. When the first switch 441 is on and the second switch 442 is off, the energy stored in the resonant tank is transferred from the primary winding 151 to the secondary winding 152.

As illustrated before, the information of the resonant current Ir flowing through the resonant tank is provided, via the first signal Vr, to the control circuit 410, to control the resonant power converter circuit 420. In the embodiment of FIG. 4, the control circuit 410 includes a zero-crossing detecting circuit 415 and a counting circuit 416.

The zero-crossing detecting circuit 415 receives the first signal Vr, detects the zero-crossing event indicating the resonant current Ir crosses zero from positive to negative based on the first signal Vr and provides a zero-crossing detecting signal 104 indicating the zero-crossing event. In one embodiment, the first signal Vr is the voltage signal representing the resonant current Ir. In some embodiments, the direction of the resonant current Ir shown in FIG. 4 is assumed to be positive, i.e., the resonant current Ir flows from the switching terminal 204 to the resonant inductor Lr. In some other embodiments, the direction of the resonant current Ir is negative when it flows from the resonant inductor Lr to the switching terminal 204.

In one embodiment, the zero-crossing detecting circuit 415 includes a comparison circuit. The comparison circuit compares the first signal Vr with a zero-crossing threshold Vt. In some embodiments, the zero-crossing threshold Vt may be equal or approximate to zero. The zero-crossing detecting circuit 415 provides the zero-crossing detecting signal 104 based on the comparison result of the first signal Vr and the zero-crossing threshold Vt. When the first signal Vr decrease to the zero-crossing threshold Vt, the zero-crossing event is detected by the zero-crossing detecting circuit 415. Different states of the zero-crossing detecting signal 104 indicate the different comparison result of the first signal Vr and the zero-crossing threshold Vt. For instance, a first state (e.g., a rising edge) of the zero-crossing detecting signal 104 indicates that the first signal Vt decreases to the zero-crossing threshold Vt, and a second state (e.g., a falling edge) of the zero-crossing detecting signal 104 indicates that the first signal Vt increases to the zero-crossing threshold Vt. In one embodiment, the zero-crossing detecting signal 104 generates a rising edge when the first signal Vr decreases from 0.5V to 0V and generates a falling edge when the first signal Vr increase from −0.5V to 0V.

The counting circuit 416 receives the zero-crossing detecting signal 104 and counts the number of times of the zero-crossing event. In some embodiments, the counting circuit 416 counts the number of the first state of the zero-crossing detecting signal 104 to obtain the number of times of the zero-crossing event. In some embodiments, when the number of times of the zero-crossing event reaches a set value, the counting circuit 416 provides a control signal 106 to control the driver 417 to turn off the first switch 441. In one embodiment, the set value is 2.

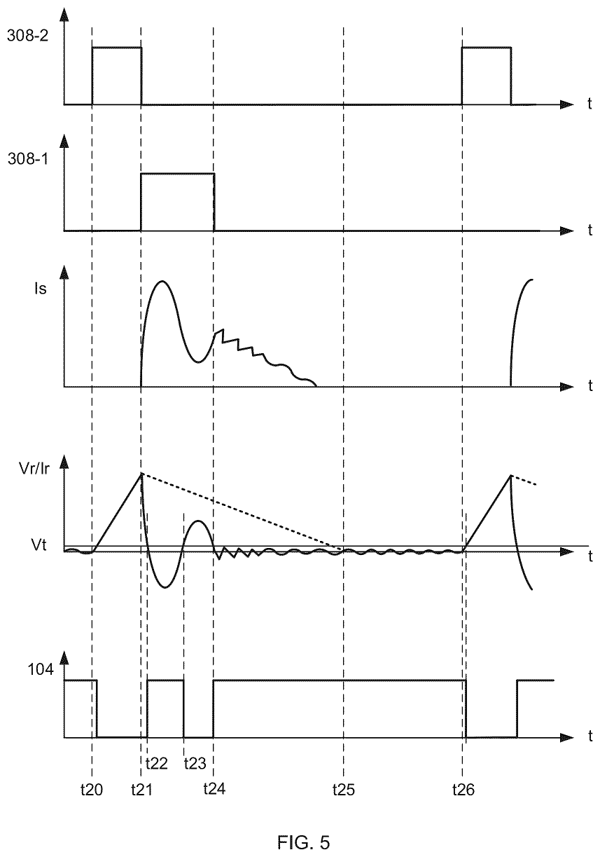

FIG. 5 shows schematic waveforms of the power device 40 in accordance with an embodiment of the present invention. The working principle of the power device 40 of the present invention is described below with reference to FIGS. 4 and 5.

In the embodiment shown in FIG. 5, a high level of the control signal 308-1 indicates the first switch 441 is turned on, while a low level of the control signal 308-1 indicates the first switch 441 is turned off. Similarly, a high level of the control signal 308-2 indicates the second switch 442 is turned on, while a low level of the control signal 308-2 indicates the second switch 442 is turned off.

As shown in FIG. 5, at time t20, the first switch 441 is turned off, the second switch 442 is turned on. Therefore, the primary winding 151 receives the input voltage Vin through the second switch 442, and the resonant current Ir flowing through the primary winding 151 increases.

At time t21, the resonant current Ir reaches its peak value, the second switch 442 is turned off, the first switch 441 is turned on. It should be understood that, in order to avoid shoot-through between the first switch 441 and the second switch 442, which may damage the circuit, a dead time is applied after the second switch 442 is turned off and before the first switch 441 is turned on. That is, the first switch 441 and the second switch 442 are both turned off during the dead time to avoid the shoot-through. The dead time is not shown in FIG. 5 for brevity since it is short. Similarly, the dead time is also applied between after the first switch 441 is turned off and before the second switch 442 is turned on. When the second switch 442 is turned off and the first switch 441 is turned on, the resonant current Ir starts to decrease, and the resonant tank formed by the resonant inductor Lr and the resonant capacitor Cr starts to oscillate with a resonant period Tr expressed as Tr=2π×\sqrt{Lr×Cr}, where Lr represents the inductance of the resonant inductor Lr, and Cr represents the capacitance of the resonant capacitor Cr.

At time t22, the first signal Vr decreases to the zero-crossing threshold Vt. As illustrated before, the first signal Vr represents the resonant current Ir, and therefore the first signal Vr and the resonant current Ir are represented by the same waveform as shown in FIG. 5. It should be understood that the resonant current Ir is the current signal, and the first signal Vr is the voltage signal, and thus they have different values. The waveforms of the first signal Vr and the resonant current Ir shown in FIG. 5 are only for schematic purposes to illustrate the working principle of the power device 40. The zero-crossing threshold Vt is approximately to zero, and therefore the moment when the first signal Vr decreases to the zero-crossing threshold Vt corresponds to the moment when the resonant current Ir crosses zero from positive to negative. At the moment when the first signal Vr decreases to the zero-crossing threshold Vt, the zero-crossing detecting signal 104 provided by the zero-crossing detecting circuit 415 changes from a low level to a high level, which generates a rising edge, to indicate the zero-crossing event. The counting circuit 416 counts the number of times of the zero-crossing event. In other words, the number is increased and counted as 1 by the counting circuit 416.

After time t22, the resonant current Ir oscillates downwardly to a negative maximum value and then starts to oscillate upwardly.

At time t23, the resonant current Ir crosses zero from negative to positive. Accordingly, the first signal Vr crosses the zero-crossing threshold Vt from negative to positive, and therefore the zero-crossing detecting signal 104 changes from the high level to the low level.

At time t24, the resonant current Ir crosses zero from positive to negative for the second time, and the first signal Vr crosses the zero-crossing threshold Vt from positive to negative. Thus, the zero-crossing event indicating the resonant current Ir crosses zero from positive to negative is detected again by the zero-crossing detecting circuit 415. Meanwhile, the zero-crossing detecting signal 104 changes from the low level to the high level to indicate the zero-crossing event. Therefore, the counting circuit 416 receives the zero-crossing detecting signal 104 and counts the zero-crossing event again. The number is increased and counted as 2 by the counting circuit 416. As a result, when the counted number reaches 2, which is the set value, the counting circuit 416 provides the control signal 106. Based on the control signal 106, the driver 417 provides the first control signal 308-1 to turn off the first switch 441.

Compared to the prior art, in the embodiment of the present invention, the first switch 441 is turned off when the resonant current Ir crosses zero from positive to negative for the second time. When the first switch 441 is turned off, the resonant tank is formed by the resonant inductor Lr, the resonant capacitor Cr and the source-drain capacitance C1 of the first switch 441. In other words, the source-drain capacitance C1 of the first switch 441 participates in the current loop of the resonant tank. After turning off the first switch 441, the resonant current Ir in the negative direction charges the source-drain capacitance C1. Due to the capacitance of the source-drain capacitance C1 is small, the voltage of the switching point 204 is pulled up quickly, and therefore the resonant inductor Lr starts to oscillate upwardly when it oscillates downwardly to a small negative value (i.e., the absolute value is small). As a result, the oscillation amplitude of the resonant current Ir decreases significantly. Thus, the power loss of the circuit is reduced, and the efficiency is improved.

At time t25, the demagnetization of the transformer 150 is finished.

At time t26, the second switch 442 is turned on again, a new switching cycle of the resonant power converter circuit 420 begins. The operation repeats and the descriptions will be omitted here for brevity.

In some embodiments of the present invention, the moment when the first signal Vr crosses the zero-crossing threshold Vt is approximately correspond to the moment when the resonant current Ir crosses zero. By adjusting the zero-crossing threshold Vt, for example, to be close to zero, the accuracy of the control of the circuit could be adjusted to improve the efficiency. However, it should be understood that, due to the non-ideal characteristics of the components of the circuit and delays probably existing in realistic circuits, there might be deviation between the moment when the first switch 441 is turned off and the moment when the resonant current Ir crosses zero from positive to negative.

It should be understood that, in the embodiments of the present invention, turning off the first switch 441 at the moment when the resonant current Ir crosses zero from positive to negative for the second time is just an example. Persons skilled in the art may turn off the first switch 441 at the moment when the resonant current Ir crosses zero from positive to negative for any counted number (e.g., 3 or 4), according to practical applications.

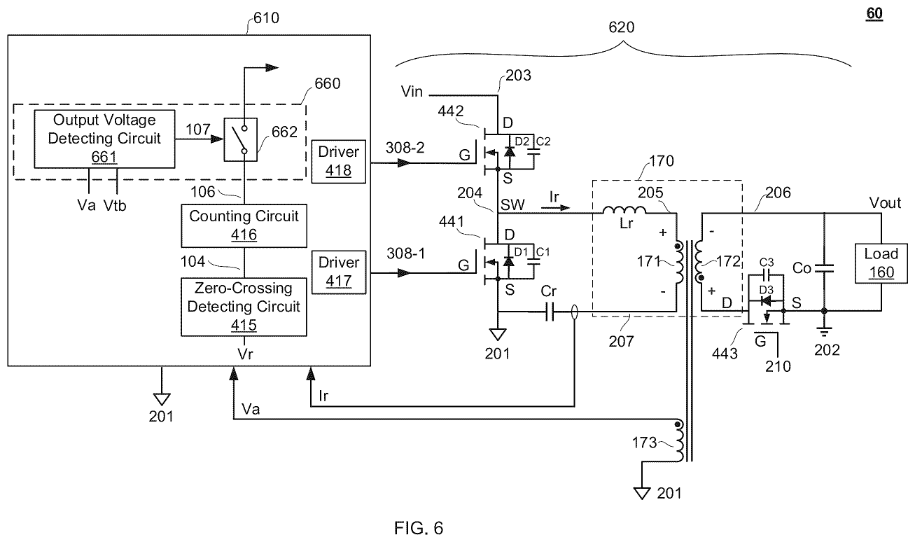

FIG. 6 shows a schematic diagram of a power device 60 in accordance with another embodiment of the present invention. As shown in FIG. 6, the power device 60 includes a resonant power converter circuit 620 and a control circuit 610 for controlling the resonant power converter circuit 620. In one embodiment, the resonant power converter circuit 620 is an asymmetrical half-bridge flyback converter, including the first switch 441, the second switch 442, the resonant capacitor Cr, a transformer 170, the third switch 443 and the output capacitor Co. The transformer 170 includes a primary winding 171, a secondary winding 172 and an auxiliary winding 173. In the embodiment of FIG. 6, the resonant inductor Lr is the leakage inductance of the primary winding 171. In some embodiments, the resonant inductor Lr is the discrete inductor. In some other embodiments, the resonant inductor Lr is a combination of the discrete inductor and the leakage inductance of the primary winding 171. The auxiliary winding 173 is magnetically coupled to the primary winding 171 and the secondary winding 172.

In the embodiment of FIG. 6, the auxiliary winding 173 provides an output voltage feedback signal Va to indicate the output voltage Vout of the resonant power converter circuit 620. In one embodiment, the voltage feedback signal Va is a voltage across the auxiliary winding 173. The value of the output voltage feedback signal Va is proportional to the output voltage Vout. The proportional coefficient is determined by the turns ratio of the auxiliary winding 173 to the secondary winding 172, i.e., Va: Vout=N173: N172. That is to say, Va=Vout×(N173/N172), where N173 represents the number of winding turns of the auxiliary winding 173, N172 represents the number of winding turns of the secondary winding 172. Persons skilled in the art may determine the turns ratio of the auxiliary winding 173 to the secondary winding 172 according to the circuit specifications and the required output voltage feedback signal Va. In some embodiments, the output voltage feedback signal Va may be provided to the control circuit 610 via a voltage dividing circuit.

In the embodiment of FIG. 6, the control circuit 610 includes the zero-crossing detecting circuit 415, the counting circuit 416 and an enable circuit 660. The working principles of the zero-crossing detecting circuit 415 and the counting circuit 416 have been described above and descriptions will be omitted here for brevity.

The control circuit 610 receives the output voltage feedback signal Va and provides the output voltage feedback signal Va to the enable circuit 660. The enable circuit 660 detects the output voltage feedback signal Va. When the detected output voltage feedback signal Va indicates that the output voltage Vout is higher than a certain value (e.g., 5V), the enable circuit 660 shields the control signal 106. Otherwise, the control signal 106 is provided to control the first control signal 308-1 to turn off the first switch 441 through the driver 417. In other words, the enable circuit 660 enables the first control signal 308-1 to turn off the first switch 441.

It should be appreciated that the enable circuit 660 enables or disables the first control signal 308-1 based on the value of the output voltage feedback signal Va. In other words, when is first control signal 308-1 is enabled, the first switch 441 is turned off by the first control signal 308-1 at the moment when the resonant current Ir crosses zero from positive to negative for the second time. In another embodiment, when the first control signal 308-1 is disabled, the first control signal 308-1 is not applied to turn off the first switch 441 at the moment when the resonant current Ir crosses zero from positive to negative for the second time. Furthermore, based on the control signal 106, the turning off of the first switch 441 at the moment when the resonant current Ir crosses zero from positive to negative for the second time is performed by the first control signal 308-1. Thus, the first control signal 308-1 could be disabled by shielding the control signal 106. In other words, the first control signal 308-1 could be disabled or enabled by shielding or not shielding the control signal 106. In some embodiments, the control signal 106 could be a data, and the affect of the data on the first control signal 308-1 is determined based on the output voltage feedback signal Va detected by the enable circuit 660.

In the embodiment of FIG. 6, the enable circuit 660 includes an output voltage detecting circuit 661 and a shielding circuit 662. The output voltage detecting circuit 661 receives the output voltage feedback signal Va and provides a shielding signal 107. The shielding circuit 662 receives the shielding signal 107 and determines whether to shield the control signal 106 based on the shielding signal 107.

In one embodiment, the output voltage detecting circuit 661 includes a comparison circuit. The comparison circuit receives the output voltage feedback signal Va, compares the output voltage feedback signal Va with a shielding threshold voltage Vtb, and provides the shielding signal 107 based on the comparison result. In one embodiment, the control signal 106 affects the control of the first switch 441 by the first control signal 308-1 when the output voltage Vout is lower than 5V. In this embodiment, when the ratio of the output voltage feedback signal Va to the output voltage Vout is 1:5, the value of shielding threshold voltage Vtb is 1 V. When the output voltage feedback signal Va is lower than 1V, the control signal 106 is allowed to be provided to the driver 417, otherwise, the control signal 106 is shielded so the control signal 106 is unable to affect the control of the first switch 441 by the first control signal 308-1. In other words, the output voltage detecting circuit 661 receives the output voltage feedback signal Va and disables or enables the first control signal 308-1 based on the output voltage feedback signal Va.

In one embodiment, the shielding circuit 662 includes a switch. The switch is controlled by the shielding signal 107. When the shielding signal 107 indicates that the output voltage Vout is lower than a threshold voltage (i.e. the output voltage feedback signal Va is lower than the shielding threshold voltage Vtb), the switch is turned on. The control signal 106 is provided to the driver 417 via the shielding circuit 662. Otherwise, the switch is turned off, the control signal 106 is shielded by the shielding circuit 662 so the control signal 106 is unable to be provided to the driver 417.

It should be appreciated that the shielding of the control signal 106 may be realized by the enable circuit 660 in other ways. For example, the shielding of the control signal 106 may be realized by a program or a digital circuit. Also, the shielding of the control signal 106 may be realized by disabling the counting circuit 416 and/or the zero-crossing circuit 415, thus the control signal 106 is unable to be provided.

Persons skilled in the art should understand that, during the on period of the third switch 443, the voltage across the auxiliary winding 173 indicates the output voltage Vout. During the off period of the third switch 443, the voltage across the auxiliary winding 173 may not indicate the output voltage Vout. Typically, a sample and hold circuit is usually used to sample and hold the voltage cross the auxiliary winding 173 during the on period of the third switch 443. Due to the method is commonly used and well known by the persons skilled in the art, the structure and description of the sample and hold circuit are omitted in the embodiment of the present invention. It should be understood that the output voltage feedback signal Va is a processed signal indicating the output voltage Vout in the embodiment of the present invention. It should also be understood that, in the embodiment of FIG. 6, the output voltage Vout is detected by using the auxiliary winding 173, which is a method to obtain information of the output voltage Vout. The information of the output voltage Vout could also be obtained by other ways, for example, by estimation of a digital circuit.

In the embodiment of FIG. 6, when the output voltage Vout is higher than the corresponding threshold, the control signal 106 is shielded so that the control signal 106 is unable to affect the control of the first switch 441. It should be understood that shielding the effect of the control signal 106 on the first switch 441 could be performed by different ways. For instance, the shielding signal 107 may be applied to disable the counting circuit 416 or the zero-crossing detecting circuit 415, or to shield the zero-crossing detecting signal 104. In some embodiments of the present invention, the enable circuit 660 controls the control signal 106 to operate at a specific output voltage condition, and to stop operating at other output voltage conditions. For example, the control signal 106 operates when the output voltage Vout is lower than 5V and stops operating when the output voltage Vout is higher than 5V.

In the embodiment of FIG. 6, the working principles of the zero-crossing detecting circuit 415 and the counting circuit 416 is similar with the embodiment of FIG. 5 and descriptions will be omitted here for brevity.

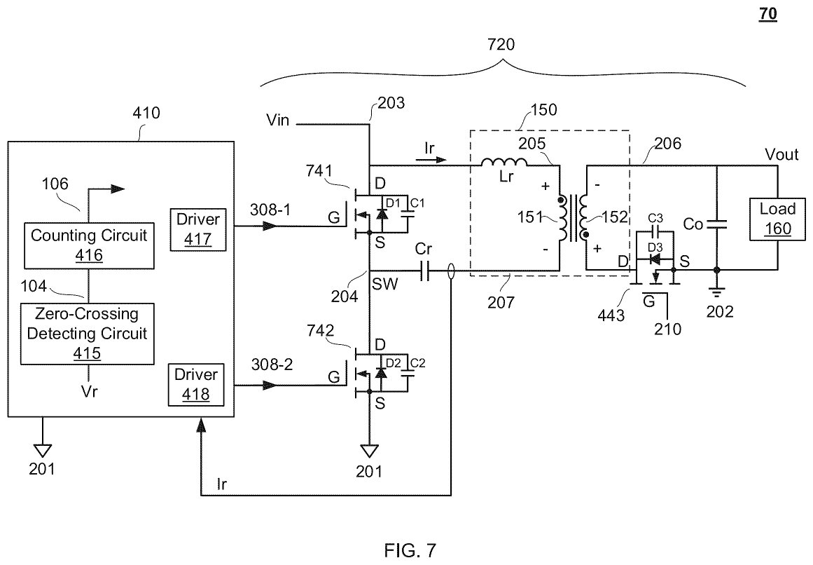

FIG. 7 shows a schematic diagram of a power device 70 in accordance with yet another embodiment of the present invention. As shown in FIG. 7, the power device 70 includes a resonant power converter circuit 720, and the control circuit 410 for controlling the resonant power converter circuit 720. In one embodiment, the resonant power converter circuit 720 is an asymmetrical half-bridge flyback converter, including a first switch 741, a second switch 742, the resonant capacitor Cr, the transformer 150, the third switch 443 and the output capacitor Co.

The structure of a primary side circuit of the resonant power converter circuit 720 shown in FIG. 7 is slightly different from the embodiment shown in FIG. 4. In FIG. 7, the first switch 741 is disposed on the high side and the second switch 742 is disposed on the low side. Specifically, the first switch 741 has a drain terminal D coupled to the input terminal 203 to receive the input voltage Vin, and a source terminal S coupled to the switching terminal 204. The second switch 742 has a drain terminal D coupled to the switching terminal 204, and a source terminal S coupled to the primary side reference ground terminal 201. The first terminal of the primary winding 151 of the transformer 150 is coupled to the input terminal 203. The second terminal of the primary winding 151 of the transformer 150 is coupled to the first terminal of the resonant capacitor Cr. The second terminal of the resonant capacitor Cr is coupled to the switching terminal 204.

In the embodiment of FIG. 7, the control circuit 410 includes the driver 417 for driving the first switch 741 and the driver 418 for driving the second switch 742. The driver 417 provides the first control signal 308-1 for controlling the first switch 741. The driver 418 provides the second control signal 308-2 for controlling the second switch 742. When the first switch 741 is turned off and the second switch 742 is turned on, the resonant tank stores energy. When the first switch 741 is turned on and the second switch 742 is turned off, the energy stored in the resonant tank is transferred from the primary winding 151 to the secondary winding 152.

It should be appreciated that, the positions of the first switch 741 and the second switch 742 in the embodiment of FIG. 7 are opposite to the positions of the first switch 441 and the second switch 442 in the embodiment of FIG. 4. However, it is the same in that the primary winding 151 transfers energy to the secondary winding 152 when the first switch 441/741 is turned on, and the primary winding 151 stores energy when the second switch 442/742 is turned on. In other words, in the embodiment of the present invention, when the first switch is turned on, the resonant tank could be formed at the primary side circuit to generate current oscillation, and when the second switch is turned on, the primary winding stores energy. Accordingly, the driver 417 provides the first control signal 308-1 for driving the first switch 741, and the driver 418 provides the second control signal 308-2 for driving the second switch 742.

The working principle of the power device 70 is similar to the power device 40. The waveforms of the signals of the power device 70 (e.g., the control signals 308-1 and 308-2, the first signal Vr, the resonant current Ir and the zero-crossing detecting signal 104) are also shown in FIG. 5, and thus will be omitted herein.

FIG. 8 shows a schematic diagram of a power device 80 in accordance with yet another embodiment of the present invention. As shown in FIG. 8, the power device 80 includes a resonant power converter circuit 820, and the control circuit 610 for controlling the resonant power converter circuit 820. In one embodiment, the resonant power converter circuit 820 is an asymmetrical half-bridge flyback converter, including the first switch 741, the second switch 742, the resonant capacitor Cr, the transformer 170, the third switch 443 and the output capacitor Co.

Compared with the embodiment of FIG. 4, in the primary side circuit of the resonant power converter circuit 720 shown in FIG. 8, the first switch 741 is disposed on the high side and the second switch 742 is disposed on the low side. Specifically, the first switch 741 has the drain terminal D coupled to the input terminal 203 for receiving the input voltage Vin, and the source terminal S coupled to the switching terminal 204. The second switch 742 has the drain terminal D coupled to the switching terminal 204, and the source terminal S coupled to the primary side reference ground terminal 201. The first terminal of the primary winding 171 of the transformer 170 is coupled to the input terminal 203. The second terminal of the primary winding 171 of the transformer 170 is coupled to the first terminal of the resonant capacitor Cr. The second terminal of the resonant capacitor Cr is coupled to the switching terminal 204.

In the embodiment of FIG. 8, the control circuit 610 includes the driver 417 for driving the first switch 741 and the driver 418 for driving the second switch 742. The driver 417 provides the first control signal 308-1 for controlling the first switch 741. The driver 418 provides the second control signal 308-2 for controlling the second switch 742. When the first switch 741 is turned off and the second switch 742 is turned on, the resonant tank stores energy. When the first switch 741 is turned on and the second switch 742 is turned off, the energy stored in the resonant tank is transferred from the primary winding 171 to the secondary winding 172.

In the embodiment of FIG. 8, the control circuit 610 includes the zero-crossing detecting circuit 415, the counting circuit 416 and the enable circuit 660. The working principles of the zero-crossing detecting circuit 415, the counting circuit 416 and the enable circuit 660 have been described above and descriptions will be omitted here for brevity.

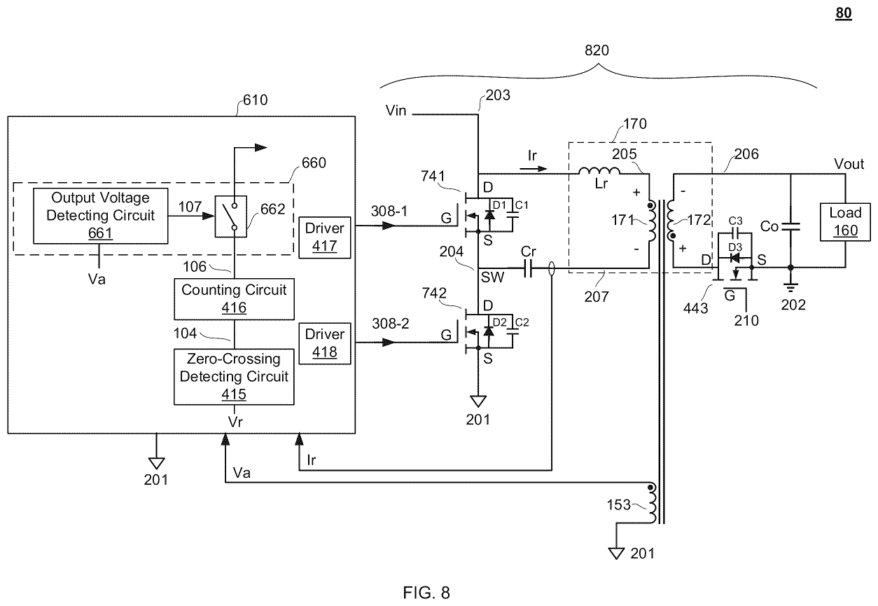

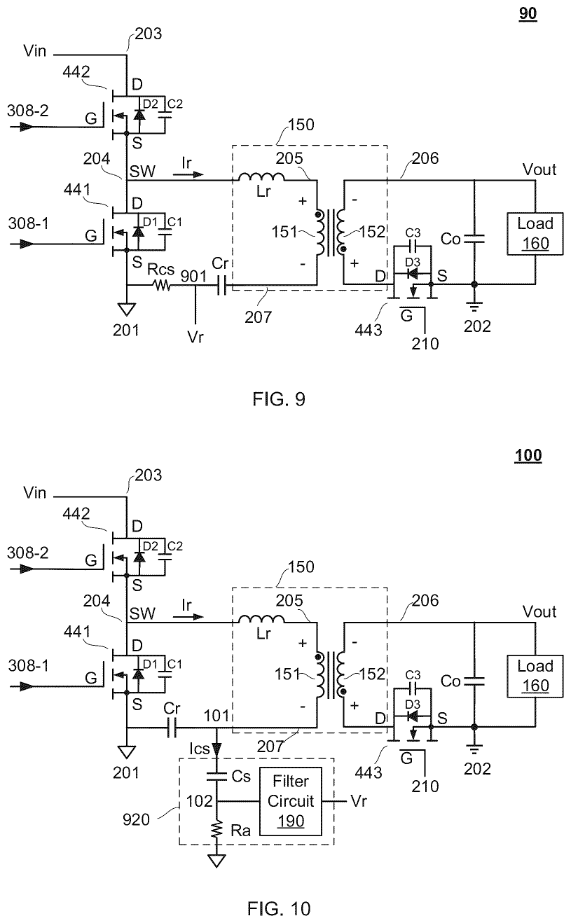

FIG. 9 shows a schematic diagram of a resonant power converter circuit 90 in accordance with an embodiment of the present invention. Compared with the resonant power converter circuit 420 shown in FIG. 4, the resonant power converter circuit 90 further includes a current sense resistor Rcs coupled in series with the resonant capacitor Cr and the primary winding 151. The current sense resistor Rcs is coupled between a detecting terminal 901 and the primary side reference ground terminal 201 and is disposed in the resonant tank which the resonant current Ir flows through. When the resonant current Ir flows through the current sense resistor Rcs, the first signal Vr is generated across the current sense resistor Rcs. In other words, the detecting terminal 901 provides the first signal Vr. The value of the first signal Vr could be expressed as Vr=Ir×Rcs. The value of the first signal Vr is proportional to the value of the resonant current Ir, and the proportionality coefficient is the resistance of the current sense resistor Rcs. The first signal Vr is provided to the aforementioned control circuits 410/610 for controlling the first switch 441/741 of the corresponding circuit.

FIG. 10 shows a schematic diagram of a resonant power converter circuit 100 in accordance with an embodiment of the present invention. Compared with the resonant power converter circuit 420 shown in FIG. 4, the resonant power converter circuit 100 further includes a current sense circuit 920. The current sense circuit 920 has an input terminal coupled to the first terminal of the resonant capacitor Cr (i.e., a resonant capacitor terminal 101) and an output terminal for providing the first signal Vr. The current sense circuit 920 includes a capacitor Cs, a resistor Ra and a filter circuit 190. The capacitor Cs and the resistor Ra are coupled in series between the resonant capacitor terminal 101 and the primary side reference ground terminal 201.

During operation of the resonant power converter circuit 100, the resonant current Ir flows through the resonant capacitor Cr and the capacitor Cs. The current Ics flowing through the capacitor Cs is associated with the capacitance of the resonant capacitor Cr and the capacitance of the capacitor Cs. The current Ics could be expressed as

$$Ics = Ir \times \frac{Cs}{Cr + Cs} ,$$

where Ics represents the value of the current Ics, Ir represents the value of the resonant current Ir, Cs represents the capacitance of the capacitor Cs, and Cr represents the capacitance of the resonant capacitor Cr. From the equation, it should be known that the value of the current Ics is proportional to the value of the resonant current Ir, and the proportionality coefficient is Cs/(Cr+Cs). When the current Ics flows through the resistor Ra, a voltage of Ics×Ra is generated across the resistor Ra, where Ra represents the resistance of the resistor Ra. Based on the above equation, the voltage across the resistor Ra could be expressed as

$$Ir \times Ra \times \frac{Cs}{Cr + Cs} .$$

the voltage across the resistor Ra is filtered by the filter circuit 190 to generate the first signal Vr, i.e.,

$$Vr = Ir \times Ra \times \frac{Cs}{Cr + Cs} .$$

From the equation, it should be known that the value of the first signal Vr is proportional to the value of the resonant current Ir, and the proportionality coefficient is

$$Ra \times \frac{Cs}{Cr + Cs} .$$

The desired value of the first signal Vr could be obtained by selecting the resistance of the resistor Ra and the capacitance of the capacitor Cs properly. The first signal Vr is provided to the aforementioned control circuits 410/610 for controlling the first switch 441/741 of the corresponding circuit.

In some embodiments, the current sense circuit 920 is integrated in the control circuit 410. In some other embodiments, the current sense circuit 920 is integrated in the control circuit 610.

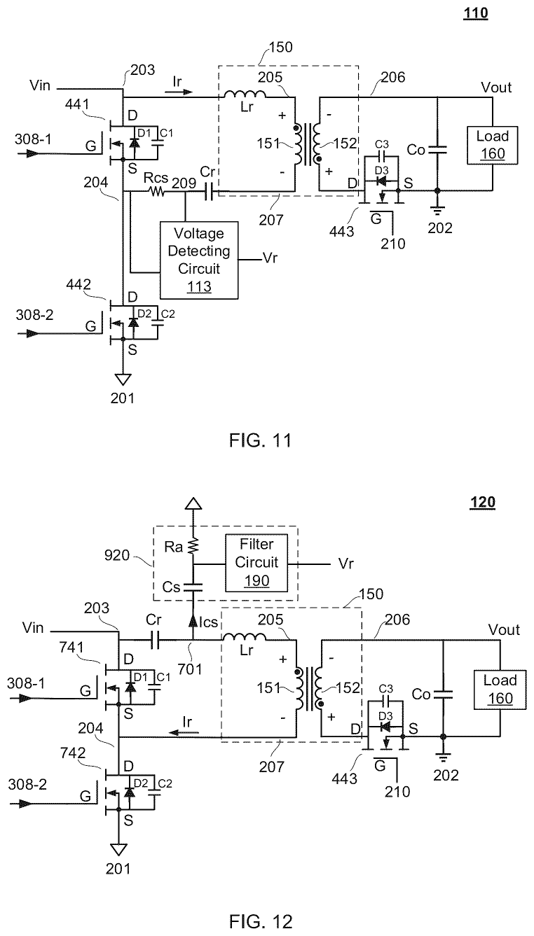

FIG. 11 shows a schematic diagram of a resonant power converter circuit 100 in accordance with an embodiment of the present invention. Compared with the resonant power converter circuit 720 shown in FIG. 7, the resonant power converter circuit 110 further includes the current sense resistor Rcs and a voltage detecting circuit 113. The current sense resistor Rcs is coupled in series with the resonant capacitor Cr and the primary winding 151. The current sense resistor Rcs is coupled between a detecting terminal 209 and the switching terminal 204 and is disposed in the resonant tank which the resonant current Ir flows through. When the resonant current Ir flows through the current sense resistors Rcs, a voltage is generated across the current sense resistors Rcs. The voltage detecting circuit 113 is coupled across the current sense resistors Rcs. The voltage detecting circuit 113 generates the first signal Vr based on the voltage across the current sense resistors Rs. In one embodiment, the voltage detecting circuit 113 includes a differential amplifying circuit. The value of the first signal Vr is directly proportional to the value of the resonant current Ir, and the proportionality coefficient is Rcs×A1, where A1 is the gain of the differential amplification circuit. The first signal Vr is provided to the aforementioned control circuits 410/610 for controlling the first switch 441/741 of the corresponding circuit. In some embodiments, the voltage detecting circuit 113 is integrated in the control circuit 410. In some other embodiments, the voltage detecting circuit 113 is integrated in the control circuit 610.

FIG. 12 shows a schematic diagram of a resonant power converter circuit 100 in accordance with an embodiment of the present invention. Compared with the resonant power converter circuit 720 shown in FIG. 7, the resonant power converter circuit 120 further includes the current sense circuit 920. The current sense circuit 920 has the input terminal coupled to the first terminal of the resonant capacitor Cr (i.e., a resonant capacitor terminal 701 shown in FIG. 12) and the output terminal for providing the first signal Vr. The current sense circuit 920 includes the capacitor Cs, the resistor Ra and the filter circuit 190. The capacitor Cs and the resistor Ra are coupled in series between the resonant capacitor terminal 701 and the primary side reference ground terminal 201.

During operation of the resonant power converter circuit 120, the resonant current Ir flows through the resonant capacitor Cr and the capacitor Cs. The current Ics flowing through the capacitor Cs is associated with the capacitance of the resonant capacitor Cr and the capacitance of the capacitor Cs. The current Ics could be expressed as

$$Ics = Ir \times \frac{Cs}{Cr + Cs} ,$$

where Ics represents the value of the current Ics, Ir represents the value of the resonant current Ir, Cs represents the capacitance of the capacitor Cs, and Cr represents the capacitance of the resonant capacitor Cr. From the equation, it should be known that the value of the current Ics is proportional to the value of the resonant current Ir, and proportionality coefficient is-Cs/(Cr+Cs). When the current Ics flows through the resistor Ra, a voltage of Ics×Ra is generated across the resistor Ra, where Ra represents the resistance of the resistor Ra. Based on the above equation, the voltage across the resistor Ra could be expressed as

$$- Ir \times Ra \times \frac{Cs}{Cr + Cs} .$$

The voltage across the resistor Ra is filtered by the filter circuit 190 to generate the first signal Vr, i.e.,

$$Vr = - Ir \times Ra \times \frac{Cs}{Cr + Cs} .$$

From the equation, it should be known that the value of the first signal Vr is proportional to the value of the resonant current Ir, and the proportionality coefficient is

$$- Ra \times \frac{Cs}{Cr + Cs} .$$

The desired value of the first signal Vr could be obtained by selecting the resistance of the resistor Ra and the capacitance of the capacitor Cs properly. The first signal Vr is provided to the aforementioned control circuits 410/610 for controlling the first switch 441/741 of the corresponding circuit.

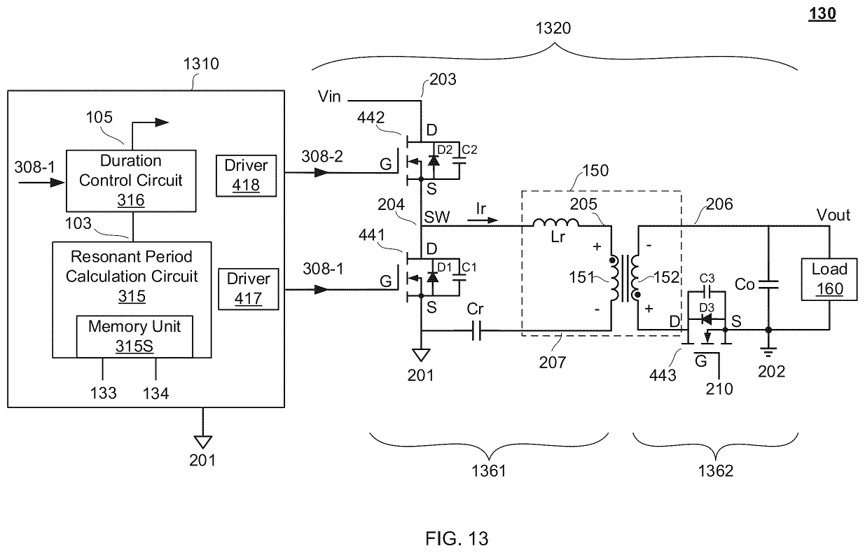

FIG. 13 shows a schematic diagram of a power device 130 in accordance with an embodiment of the present invention. As shown in FIG. 13, the power device 130 includes a resonant power converter circuit 1320, and a control circuit 1310 for controlling the resonant power converter circuit 1320. In one embodiment, the resonant power converter circuit 1320 is an asymmetrical half-bridge flyback converter, including the first switch 441, the second switch 442, the resonant capacitor Cr, the transformer 150, the third switch 443 and the output capacitor Co. The transformer 150 includes the primary winding 151 and the secondary winding 152. In the embodiment of FIG. 13, the resonant inductor Lr is the leakage inductance of the primary winding 151. In some embodiments, the resonant inductor Lr is the discrete inductor. In some other embodiments, the resonant inductor Lr is the combination of the discrete inductor and the leakage inductance of the primary winding 151.

It should be understood that the primary winding 151 and components electrically coupled to the primary winding 151 (e.g., the first switch 441, the second switch 442, the resonant capacitor Cr and other components not shown in FIG. 13) form a primary side circuit 1361. The secondary winding 152 and components electrically coupled to the secondary winding 152 (e.g., the third switch 443, the output capacitor Co and other components not shown in FIG. 13) form a secondary side circuit 1362.

In the embodiment of FIG. 13, during the on period of the first switch 441 and the off period of the second switch 442, the information of the resonant current Ir flowing through the resonant tank is estimated based on the capacitance of the resonant capacitor Cr and the inductance of the resonant inductor Lr. In FIG. 13, label 133 represents the capacitance information of the resonant capacitor Cr and label 134 represents the inductance information of the resonant inductor Lr. The capacitance information of the resonant capacitor Cr and the inductance information of the resonant inductor Lr are provided to the control circuit 1310. In some embodiments, the capacitance information of the resonant capacitor Cr and the inductance information of the resonant inductor Lr are provided to the control circuit 1310 in the form of data. In some other embodiments, the capacitance information of the resonant capacitor Cr and the inductance information of the resonant inductor Lr are provided to the control circuit 1310 in the form of signals.

The control circuit 1310 includes a resonant period calculation circuit 315 and a duration control circuit 316. The resonant period calculation circuit 315 includes a memory unit 315S for storing the capacitance information 133 of the resonant capacitance Cr and the inductance information 134 of the resonant inductor Lr. The resonant period Tr of the resonant tank of the resonant power converter circuit 1320 is calculated by the resonant period calculation circuit 315 based on the capacitance of the resonant capacitor Cr and the inductance of the resonant inductor Lr, which could be expresses as Tr=2π\sqrt{Lr×Cr}. Thus, the resonant period information 103 having information of the resonant period Tr is obtained. The duration control circuit 316 receives the resonant period information 103 and provides a control signal 105 for controlling the on-time of the first switch 441 based on the resonant period Tr. The duration control circuit 316 provides the control signal 105 to turn off the first switch 441 after 1.1 to 1.4 times of the resonant period Tr past from a turn-on time of the first switch 441 (i.e., a time when the first switch 441 turns on). In other words, the duration control circuit 316 provides the control signal 105 to turn off the first switch 441 when the on-time of the first switch 441 is within the range of 1.1 to 1.4 times of the resonant period Tr. In one embodiment, the control signal 105 controls the first control signal 308-1 to turn off the first switch 441 through the driver 417. In one embodiment, the duration control circuit 316 further receives the first control signal 308-1 to determine the turn-on time of the first switch 441. It should be appreciated that the turn-off time of the first switch 441 could be calculated based on other signals indicating the turn-on time of the first switch 441 (e.g., an intermediate signal of a circuit used for generating the first control signal 308-1 in the control circuit 1310) in the embodiments of the present invention.

In one embodiment, the control circuit 1310 turns off the first switch 441 when the on-time of the first switch 441 is 1.25 times of the resonant period Tr. Ideally, a moment when the on-time of the first switch 441 reaches 1.25 times of the resonant period Tr corresponds to the moment when the resonant current Ir crosses zero from positive to negative for the second time. However, since the non-ideal characteristics of the components of the circuits and delays probably existing in realistic circuits, the moment when the on-time of the first switch 441 is 1.25 times of the resonant period Tr may not accurately correspond to the moment when the resonant current Ir crosses zero from positive to negative for the second time. Therefore, in practice application, persons of ordinary skill in the art could turn off the first switch 441 when the on-time of the first switch 441 is within the range of 1.1 to 1.4 times of the resonant period Tr. In other words, the moment when the resonant current Ir crosses zero from positive to negative for the second time locates in the time period that the on-time of the first switch 441 is within the range of 1.1 to 1.4 times of the resonant period Tr.

In some embodiments, the resonant period Tr may be obtained by other ways. For example, in some applications, the resonant period Tr is preset, and the capacitance of the resonant capacitor Cr and the inductance of the resonant inductor Lr are determined based on the preset resonant period Tr. In some embodiments, the preset resonant period Tr may be stored directly in the memory unit 315S. In some other embodiments, the data having information of the preset resonant period Tr may be received by the control circuit 1310 via an interface circuit.

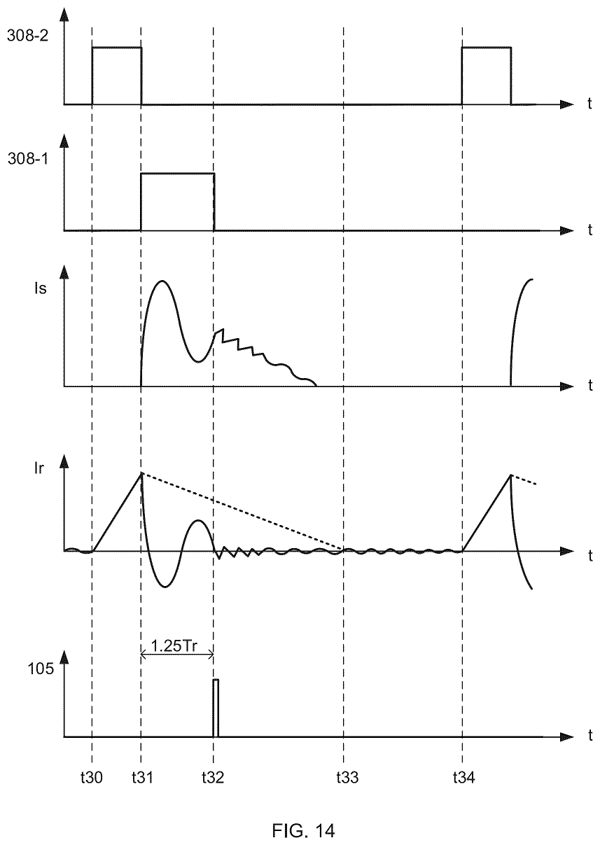

FIG. 14 shows schematic waveforms of the power device 130 in accordance with an embodiment of the present invention. The working principle of the power device 130 is described below with reference to FIGS. 13 and 14.

In the embodiment shown in FIG. 14, the high level of the control signal 308-1 indicates the first switch 441 is turned on, while the low level of the control signal 308-1 indicates the first switch 441 is turned off. Similarly, the high level of the control signal 308-2 indicates the second switch 442 is turned on, while the low level of the control signal 308-2 indicates the second switch 442 is turned off.

As shown in FIG. 14, at time t30, the first switch 441 is turned off, the second switch 442 is turned on. Therefore, the primary winding 151 receives the input voltage Vin through the second switch 442, and the current Ir flowing through the primary winding 151 increases.

At time t31, the current Ir reaches its peak value, the second switch 442 is turned off and the first switch 441 is turned on. It should be understood that, in order to avoid shoot-through between the first switch 441 and the second switch 442, which may damage the circuit, the dead time is applied after the second switch 442 is turned off and before the first switch 441 is turned on. That is, the first switch 441 and the second switch 442 are both turned off to avoid the shoot-through. The dead time is not shown in FIG. 14 for brevity since it is short. Similarly, the dead time is also applied after the first switch 441 is turned off and before the second switch 442 is turned on. When the second switch 442 is turned off and the first switch 441 is turned on, the resonant current Ir starts to decrease, and the resonant tank formed by the resonant inductor Lr and the resonant capacitor Cr starts to oscillate with the resonant period Tr expressed as Tr=2π\sqrt{Lr×Cr}, where Lr represents the inductance of the resonant inductor Lr and Cr represents the capacitance of the resonant capacitor Cr.

At time t32, the on-time of the first switch 441 reaches 1.25 times of the resonant period Tr, the control signal 105 generates a pulse. The pulse controls the first control signal 308-1 to turn off the first switch 441 through the driver 417.

At time t33, the demagnetization of the transformer 150 is finished.

At time t34, the second switch 442 is turned on again and a new switching cycle of the resonant power converter circuit 1320 begins. The operation repeats and the descriptions will be omitted here for brevity.

The control circuit 1310 in the embodiments of the invention is not only applicable to the resonant power converter circuits having the first switch 441 disposed on the low side (e.g., the resonant power converter circuit 1320 shown in FIG. 13), but also to the resonant power converter circuits having the first switch 741 disposed on the high side (e.g., the resonant power converter circuit 820 shown in FIG. 8).

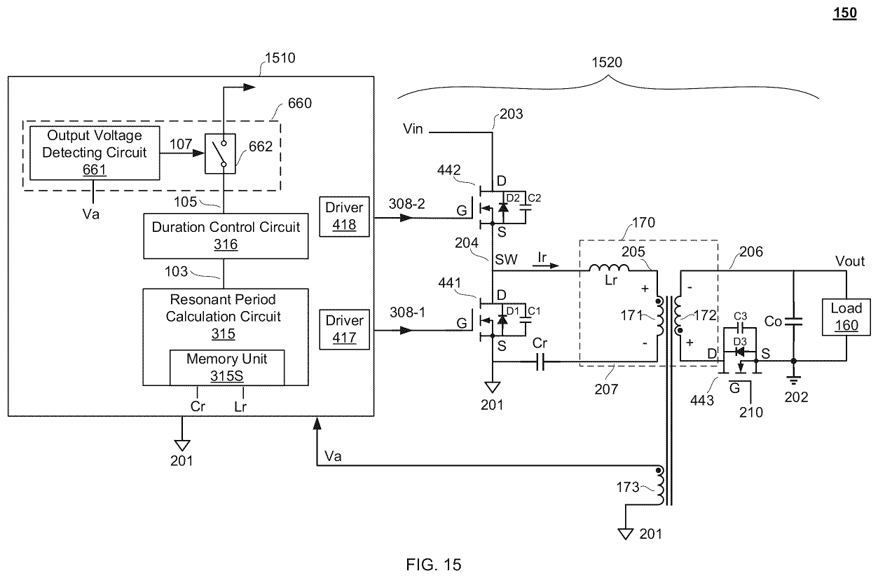

FIG. 15 shows a schematic diagram of a power device 150 in accordance with an embodiment of the present invention. As shown in FIG. 15, the power device 150 includes a resonant power converter circuit 1520, and a control circuit 1510 for controlling the resonant power converter circuit 1520. In one embodiment, the resonant power converter circuit 1520 is an asymmetrical half-bridge flyback converter, including the first switch 441, the second switch 442, the resonant capacitor Cr, the transformer 170, the third switch 443 and the output capacitor Co. The transformer 170 includes the primary winding 171, the secondary winding 172 and the auxiliary winding 173. In the embodiment of FIG. 15, the resonant inductor Lr is the leakage inductance of the primary winding 171. In some embodiments, the resonant inductor Lr is the discrete inductor. In some other embodiments, the resonant inductor Lr is the combination of the discrete inductor and the leakage inductance of the primary winding 171. In the embodiment of FIG. 15, the auxiliary winding 173 provides the output voltage feedback signal Va for indicating the output voltage Vout of the resonant power converter circuit 1520. The value of the output voltage feedback signal Va is proportional to the output voltage Vout. The proportional coefficient is determined by the turns ratio of the auxiliary winding 173 to the secondary winding 172, i.e., Va: Vout=N173: N172. That is to say, Va=Vout×(N173/N172), where N173 represents the number of winding turns of the auxiliary winding 173, N172 represents the number of winding turns of the secondary winding 172. Persons skilled in the art may determine the turns ratio of the auxiliary winding 173 to the secondary winding 172 according to the circuit specifications and the required output voltage feedback signal Va. In some embodiments, the output voltage feedback signal Va may be provided to the control circuit 1510 via a voltage dividing circuit.

In the embodiment of FIG. 15, the control circuit 1510 includes the resonant period calculation circuit 315, the duration control circuit 316, and the enable circuit 660. The circuit structures and working principles of the resonant period calculation circuit 315, the duration control circuit 316 and the enable circuit 660 have been described above, and descriptions will not be repeated here.

The control circuit 1510 receives the output voltage feedback signal Va and provides the output voltage feedback signal Va to the enable circuit 660. The enable circuit 660 detects the output voltage feedback signal Va. The enable circuit 660 shields the control signal 105 when the output voltage feedback signal Va indicates that the output voltage Vout is higher than the certain value (e.g., 5V), otherwise, the control signal 105 is provided to control the first control signal 308-1 to turn off the first switch 441 through the driver 417.

In the embodiment of FIG. 15, when the output voltage Vout is higher than the corresponding threshold, the control signal 105 is shielded so that the control signal 105 is unable to perform the control of the first switch 441. In other words, the control signal 105 is unable to control the first control signal 308-1 to turn off the first switch 441 through the driver 417.

It should be appreciated that, the enable circuit 660 enables or disables the first control signal 308-1 based on the output voltage feedback signal Va. In one embodiment, when the first control signal 308-1 is enabled, the first control signal 308-1 is applied to turn off the first switch 441 at the moment when the resonant current Ir crosses zero from positive to negative for the second time. In another embodiment, when the first control signal 308-1 is disabled, the first control signal 308-1 is not applied to turn off the first switch 441 at the moment when the resonant current Ir crosses zero from positive to negative for the second time. Furthermore, based on the control signal 105, the turning off of the first switch 441 at the moment when the resonant current Ir crosses zero from positive to negative for the second time is performed by the first control signal 308-1. Thus, the first control signal 308-1 could be disabled by shielding the control signal 105. In other words, the first control signal 308-1 could be disabled or enabled by shielding or not shielding the control signal 105. In some embodiments, the control signal 105 could be a data, and the effect of the data on the first control signal 308-1 is determined based on the output voltage feedback signal Va detected by the enable circuit 660.

It should be understood that, the shielding the effect of the control signal 105 on the first switch 441 could be performed by different ways. For instance, the shielding signal 107 may be applied to disable the duration control circuit 316 and/or the resonant period calculation circuit 315. In some embodiments of the present invention, the enable circuit 660 controls the control signal 105 to operate at a specific output voltage condition, and to stop operating at other output voltage conditions. For example, the control signal 106 operates when the output voltage Vout is lower than 5V and stops operating when the output voltage Vout is higher than 5V. In the embodiments of the present invention, the enable circuit 660 controls the control signal 105 to operate at the particular output voltage condition by shielding the control signal 105. It should be appreciated that, other ways to achieve the shielding the control signal 105 are also applicable in the embodiments of the present invention. For example, the duration control circuit 316 and/or the resonant period calculation circuit 315 could be disabled, and therefore the control signal 105 could not be provided and the shielding of the control signal 105 is achieved.

The working principles of the resonant period calculation circuit 315 and the duration control circuit 316 have been described above and descriptions will be omitted here for brevity. In some embodiments, the resonant period calculation circuit 315 and the duration control circuit 316 are realized by digital circuits or programs. In these embodiments, some of the connections and signals shown in FIGS. 13 and 15 may be not actually present and may be realized by data and links. For example, the resonant period information 103 may be a data having information of the resonant period Tr. The data may be stored in a register or other readable storage units. In other words, the embodiments of the present invention are only for illustrating the working principle of the circuit, and various forms of circuits may be derived to implement the embodiments of the present invention based on the working principle illustrated in the specification.

The control circuit 1310 and 1510 in the embodiments of the invention are not only applicable to the resonant power converter circuits having the first switch 441 disposed on the low side (e.g., the resonant power converter circuit 1320 shown in FIG. 13 and the resonant power converter circuit 1520 shown in FIG. 15), but also to the resonant power converter circuits having the first switch 741 disposed on the high side (e.g., the resonant power converter circuit 820 shown in FIG. 8).

It should be understood that the control circuit in the embodiments of the present invention may be performed by a digital circuit or a program. Therefore, the circuit structures and the signals in the control circuit may not actually exist. For example, the control signal 106 may be information existed in the form of data. At the same time, some of the input terminals and output terminals in the embodiments of the present invention may be pins of the integrated circuit or ports of the circuit, or data interfaces for transmission. For example, the resonant current information associated with the resonant current flowing through the resonant tank could be received via a pin of the integrated circuit. The pin is used for receiving a voltage signal or a current signal indicating the resonant current or for receiving signals indicating the leakage inductance of the primary winding of the transformer and the capacitance of the resonant capacitor. Also, the resonant current information associated with the resonant current flowing through the resonant tank could be received via the data interface. The data interface is used for receiving information of the leakage inductance of the primary winding of the transformer and the capacitance of the resonant capacitor, or for receiving a data having the resonant current information.

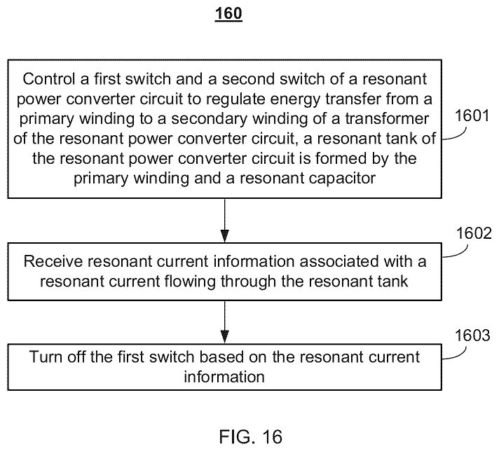

FIG. 16 shows a flow diagram of a method 160 for controlling a resonant power converter circuit in accordance with an embodiment of the present invention. The resonant power converter circuit includes the resonant power converter circuits of the above-mentioned embodiments. The resonant power converter circuit includes a first switch, a second switch, a transformer and a resonant capacitor. The first switch and the second switch are coupled in series between an input terminal and a primary side reference ground terminal. When the first switch is turned on, the resonant capacitor and a resonant inductor of the resonant power converter circuit oscillate. In one embodiment, the resonant inductor is a leakage inductance of a primary winding of the transformer. In some embodiments, the resonant inductor is a discrete inductor. In some other embodiments, the resonant inductor is a combination of the discrete inductor and the leakage inductance of the primary winding. The control method 160 includes steps 1601-1604.

At step 1601, the first switch and the second switch of the resonant power converter circuit are controlled to regulate energy transfer from the primary winding to a secondary winding of the transformer of the resonant power converter circuit. A resonant tank of the resonant power converter circuit is formed by the primary winding and the resonant capacitor.

At step 1602, resonant current information associated with a resonant current flowing through the resonant tank is received.

At step 1603, the first switch is turned off based on the resonant current information.

In one embodiment, the control method 160 further includes a step 1604. At step 1604, an output voltage of the resonant power converter circuit is detected and the step of turning off the first switch based on the resonant current information is performed when the output voltage is lower than a set value.

In one embodiment, the resonant current information includes a value of the resonant current. The step 1603 includes the following steps. A zero-crossing event indicating the resonant current crosses zero from positive to negative is detected. The first switch is turned off when the number of times of the zero-crossing event reaches 2.

In one embodiment, the resonant current information includes a resonant period of the resonant tank during the first switch is on and the second switch is off. The step 1603 includes the following step. The first switch is turned off when an on-time of the first switch is within a range of 1.1 to 1.4 times of the resonant period. In a further embodiment, the first switch is turned off when the on-time of the first switch reaches 1.25 times of the resonant period.

In one embodiment, the resonant current information includes the leakage inductance of the primary winding of the transformer and a capacitance of the resonant capacitor in the resonant tank. The step 1603 includes the following steps. The resonant period of the resonant circuit is calculated based on the leakage inductance and the capacitance of the resonant capacitor. The first switch is turned off when the on-time of the first switch is within the range of 1.1 to 1.4 times of the calculated resonant period. In a further embodiment, the first switch is turned off when the on-time of the first switch reaches 1.25 times of the calculated resonant period.

It should be understood, the circuit and the workflow described in the present invention are just for schematic illustration. Any circuit can realize the function and operation of the present invention does not depart from the spirit and the scope of the invention.

While specific embodiments of the present invention have been provided, it is to be understood that these embodiments are for illustration purposes and not limiting. Since the invention can be practiced in various forms without distracting the spirit or the substance of the invention. It should be appreciated that the above embodiments are not confined to any aforementioned specific detail but should be explanatory broadly within the spirit and scope limited by the appended claims. Thus, all the variations and modification falling into the scope of the claims and their equivalents should be covered by the appended claims.

What is claimed is:

1. A control circuit for an asymmetrical half-bridge flyback converter with a first switch, a second switch, a transformer and a resonant capacitor, comprising:
an input terminal configured to receive resonant current information, wherein the resonant current information is associated with a resonant current flowing through a resonant tank formed by a primary winding of the transformer and the resonant capacitor; and
an output terminal configured to provide a first control signal to turn off the first switch of the asymmetrical half-bridge flyback converter based on the resonant current information.

2. The control circuit of claim 1, further comprising:
an output voltage detecting circuit configured to receive an output voltage feedback signal indicating an output voltage of the asymmetrical half-bridge flyback converter, and to disable or enable the first control signal based on the output voltage feedback signal.

3. The control circuit of claim 2, wherein the output voltage feedback signal is provided by an auxiliary winding magnetically coupled to the primary winding.

4. The control circuit of claim 1, wherein the resonant current information comprises a first signal indicating a value of the resonant current.

5. The control circuit of claim 4, further comprising:
a zero-crossing detecting circuit configured to receive the first signal indicating the value of the resonant current, to detect a zero-crossing event indicating the resonant current crosses zero from positive to negative based on the first signal, and to provide a zero-crossing detecting signal indicating the zero-crossing event; and
a counting circuit configured to receive the zero-crossing detecting signal, and to count a number of times of the zero-crossing event based on the zero-crossing detecting signal; and wherein
the first control signal turns off the first switch when the number of times of the zero-crossing event reaches a set value.

6. The control circuit of claim 1, wherein the resonant current information comprises a resonant period of the resonant tank.

7. The control circuit of claim 6, wherein the first control signal turns off the first switch when an on-time of the first switch is within a range of 1.1 to 1.4 times of the resonant period of the resonant tank.

8. The control circuit of claim 1, wherein the resonant current information comprises an inductance of a resonant inductor and a capacitance of the resonant capacitor in the resonant tank.

9. The control circuit of claim 8, further comprising:
a resonant period calculation circuit configured to calculate a resonant period based on the inductance of the resonant inductor and the capacitance of the resonant capacitor; and
a duration control circuit configured to control the first control signal to turn off the first switch when an on-time of the first switch is within a range of 1.1 to 1.4 times of the calculated resonant period.

10. A power device, comprising:
an asymmetrical half-bridge flyback converter comprising a first switch, a second switch, a transformer and a resonant capacitor, wherein the first switch and the second switch are coupled in series between an input terminal and a primary side reference ground terminal, wherein the transformer comprises a primary winding and a secondary winding, and a resonant tank is formed by the primary winding and the resonant capacitor; and
a control circuit configured to receive resonant current information associated with a resonant current flowing through the resonant tank, and to provide a first control signal to turn off the first switch based on the resonant current information.

11. The power device of claim 10, wherein the control circuit comprises:
an output voltage detecting circuit configured to receive an output voltage feedback signal indicating an output voltage of the asymmetrical half-bridge flyback converter and to disable or enable the first control signal based on the output voltage feedback signal.

12. The power device of claim 11, wherein the output voltage feedback signal is provided by an auxiliary winding magnetically coupled to the primary winding.

13. The power device of claim 10, wherein the resonant current information comprises a first signal indicating the resonant current, and the control circuit comprises:
a zero-crossing detecting circuit configured to receive the first signal indicating the resonant current, to detect a zero-crossing event indicating the resonant current crosses zero from positive to negative based on the first signal, and to provide a zero-crossing detecting signal indicating the zero-crossing event; and
a counting circuit configured to receive the zero-crossing detecting signal, and to count a number of times of the zero-crossing event based on the zero-crossing detecting signal; and wherein
the first control signal turns off the first switch when the number of times of the zero-crossing event reaches a set value.

14. The power device of claim 10, wherein the resonant current information comprises a resonant period of the resonant tank during the first switch is on and the second switch is off, and the first control signal turns off the first switch when an on-time of the first switch is within a range of 1.1 to 1.4 times of the resonant period of the resonant tank.

15. The power device of claim 10, wherein the resonant current information comprises an inductance of a resonant inductor and a capacitance of the resonant capacitor in the resonant tank, and the control circuit comprises:
a resonant period calculation circuit configured to calculate a resonant period based on the inductance of the resonant inductor and the capacitance of the resonant capacitor; and
a duration control circuit configured to control the first control signal to turn off the first switch when an on-time of the first switch is within a range of 1.1 to 1.4 times of the resonant period.

16. A method for controlling a resonant power converter circuit with a first switch, a second switch, a transformer and a resonant capacitor, comprising:
controlling the first switch and the second switch in the resonant power converter circuit to regulate energy transfer from a primary winding to a secondary winding of the transformer, wherein a resonant tank of the resonant power converter circuit is formed by the primary winding and the resonant capacitor;
receiving resonant current information associated with a resonant current flowing through the resonant tank; and
turning off the first switch based on the resonant current information.

17. The method of claim 16, further comprising:
detecting an output voltage of the resonant power converter circuit and performing the step of turning off the first switch based on the resonant current information when the output voltage is lower than a set value.

18. The method of claim 16, wherein the resonant current information comprises a value of the resonant current, and the step of turning off the first switch based on the resonant current information comprises:
detecting a zero-crossing event indicating the resonant current crosses zero from positive to negative; and
turning off the first switch when a number of times of the zero-crossing event reaches a set value.

19. The control method of claim 16, wherein the resonant current information comprises a resonant period of the resonant tank during the first switch is on and the second switch is off, and the step of turning off the first switch based on the resonant current information comprises:
turning off the first switch when an on-time of the first switch is within a range of 1.1 to 1.4 times of the resonant period of the resonant tank.

20. The control method of claim 16, wherein the resonant current information comprises an inductance of a resonant inductor and a capacitance of the resonant capacitor in the resonant tank, and the step of turning off the first switch based on the resonant current information comprises:
calculating a resonant period based on the inductance of the resonant inductor and the capacitance of the resonant capacitor; and
turning off the first switch when an on-time of the first switch is within a range of 1.1 to 1.4 times of the calculated resonant period.
